(19) United States
(12) Patent Application Publication
(10) Pub. No.: US 2014/0320426 A1
(43) Pub. Date: Oct. 30, 2014

(54) ELECTRONIC APPARATUS, CONTROL METHOD AND STORAGE MEDIUM

(71) Applicant: KABUSHIKI KAISHA TOSHIBA, Tokyo (JP)

(72) Inventor: Kunio Baba, Ome-shi (JP)

(73) Assignee: KABUSHIKI KAISHA TOSHIBA, Tokyo (JP)

(21) Appl. No.: 14/094,092

(22) Filed: Dec. 2, 2013

(30) Foreign Application Priority Data
Apr. 24, 2013 (JP) 2013-091486

(51) Int. Cl. G06F 3/041; G09G 5/10

(52) U.S. Cl. CPC G06F 3/0416; G09G 5/10
USPC 345/173

(57) ABSTRACT

According to one embodiment, an electronic apparatus includes a touch screen display, an illumination sensor, a controller and a setting module. The controller is configured to control luminance of the touch screen display based on a signal from the illumination sensor. The setting switch is configured to turn off control of the luminance by the controller to avoid a variation in luminance of the touch screen display, while an input to the touch screen display is performed.

### CROSS-REFERENCE TO RELATED APPLICATIONS

This application is based upon and claims the benefit of priority from Japanese Patent Application No. 2013-091486, filed Apr. 24, 2013, the entire contents of which are incorporated herein by reference.

### FIELD

Embodiments described herein relate generally to a technique for controlling the luminance of a touch screen display in an electronic apparatus.

### BACKGROUND

In recent years, various battery-powered and easily-carried electronic apparatuses, including tablet terminals and smartphones, have been developed. Most of these electronic apparatuses are equipped with touch screen displays in order to facilitate user's input operations.

A user can give an electronic apparatus an instruction for performing a function related to an icon or menu displayed on the touch screen display by touching it with his/her finger or a pen.

The above electronic apparatuses are also equipped with various power saving functions in order to increase the continuous operating time with battery driving. One of them is controlling the luminance of the touch screen display in accordance with a situation.

An input operation using the touch screen display is applied to enter a document in an electronic apparatus in handwriting, in addition to give an instruction thereto. Lately, for example, there are cases where a user attends a meeting with an electronic apparatus as described above, and he/she makes a memorandum by performing handwriting input to the touch screen display.

On the other hand, there is a technique for controlling the luminance of a touch screen display in accordance with the surrounding brightness detected by an illumination sensor, as the above luminance control technique using the situation. In many cases, this illumination sensor is provided close to the periphery of the display surface of the touch screen display.

While a handwriting input to the touch screen display is being performed, there are cases where the illumination sensor (that is provided close to the periphery of the display surface of the touch screen display) is covered by the user's hand. In this case, the illuminance value detected by the illumination sensor may be varied. As a result, the luminance of the touch screen display could vary. It is not preferable for the luminance of the touch screen display to vary in the course of a handwriting input to the touch screen display.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary view illustrating an appearance of an electronic apparatus of an embodiment.

FIG. 2 is an exemplary view illustrating a system configuration of the electronic apparatus of the embodiment.

FIG. 3 is an exemplary block diagram for explaining a function of a screen luminance control utility program operative in the electronic apparatus of the embodiment.

FIG. 4 is an exemplary view illustrating a scene in which the luminance of the touch screen display is controlled by the screen luminance control utility program operative in the electronic apparatus of the embodiment.

FIG. 5 is an exemplary flowchart showing a procedure (first pattern) through which the luminance of the touch screen display is controlled in the electronic apparatus of the embodiment.

FIG. 6 is an exemplary flowchart showing another procedure (second pattern) through which the luminance of the touch screen display is controlled in the electronic apparatus of the embodiment.

### DETAILED DESCRIPTION

Various embodiments will be described hereinafter with reference to the accompanying drawings.

In general, according to one embodiment, an electronic apparatus includes a touch screen display, an illumination sensor, a controller and a setting module. The controller is configured to control luminance of the touch screen display based on a signal from the illumination sensor. The setting switch is configured to turn off control of the luminance by the controller to avoid a variation in luminance of the touch screen display, while an input to the touch screen display is performed.

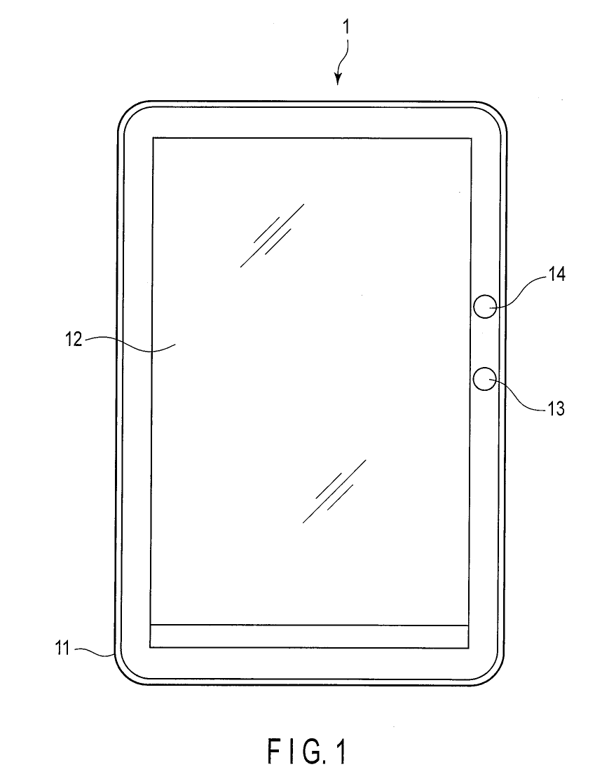

An electronic apparatus of this embodiment can be implemented using a portable electronic apparatus that permits a touch input with a pen or a finger. Examples of this portable electronic apparatus include a tablet terminal, a notebook personal computer, a smartphone, and a personal digital assistant (PDA). FIG. 1 is an exemplary view illustrating an appearance of the electronic apparatus of this embodiment. As illustrated in FIG. 1, herein, it is assumed that the electronic apparatus is implemented using a tablet terminal 1.

The tablet terminal 1 includes a main body 11, a touch screen display 12, a camera 13 and an illumination sensor 14. The touch screen display 12 is attached to the upper surface of the main body 11 and is stacked thereon. The camera 13 and the illumination sensor 14 are arranged on the upper surface of the main body 11 and close to the periphery of the display surface of the touch screen display 12. The camera 13 is disposed close to an edge of the upper surface of the main body 11 and in the middle of the side, in order to face the lens toward a subject easily. In general, the lens of the camera 13 is less likely to be covered by a user's hand. In the light of this fact, the illumination sensor 14 is disposed close to the camera 13 (in order not to be covered by the user's hand).

The main body 11 has a thin box-shaped casing. The touch screen display 12 contains a flat panel display, and a sensor configured to detect a position of a screen in the flat panel display with which a pen or a finger makes contact. The flat panel display may be, for example, a liquid crystal display (LCD). The sensor may be, for example, a capacitive touch panel or an electromagnetic induction type digitizer. Hereinafter, it is assumed that two sensors, or a touch panel and a digitizer, are incorporated in the touch screen display 12.

Both the touch panel and the digitizer cover the screen of the flat panel display. The touch screen display 12 can detect a touch input to the screen with the finger as well as the pen. The pen may be, for example, an electromagnetic induction type pen. The user can perform a handwriting input to the touch screen display 12 by using the pen or the finger. A path of the handwriting input (handwriting) which is described by the pen or the finger is displayed on the screen.

The illumination sensor 14 is a device configured to control the luminance of the touch screen display 12 in accordance with the surrounding brightness. As described above, the illumination sensor 14 is disposed close to the camera 13 (that is less likely to be covered by the user's hand), in order not to be covered by the user's hand.

Even when the illumination sensor 14 is disposed close to the camera 13, however, it is still likely to be covered by the user's hand in the course of a handwriting input to the touch screen display 12. If the illumination sensor 14 is covered by the user's hand, the illuminance value sensed by the illumination sensor 14 may be varied. As a result, the luminance of the touch screen display could vary. It is not desirable for the luminance of the touch screen display 12 to vary in the course of a handwriting input to the touch screen display 12. The tablet terminal 1 includes a mechanism for preventing the luminance of the touch screen display 12 from varying in the course of a handwriting input to the touch screen display 12. This mechanism will be described below in detail.

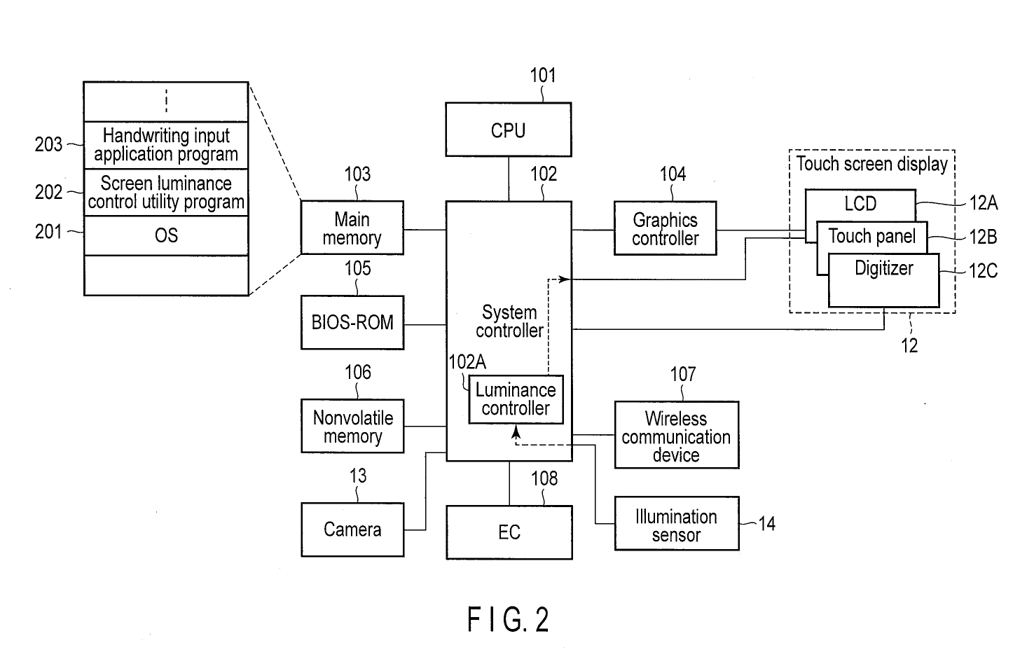

FIG. 2 is an exemplary view illustrating a system configuration of the tablet terminal 1 of this embodiment.

As illustrated in FIG. 2, the tablet terminal 1 includes a CPU 101, a system controller 102, a main memory 103, a graphics controller 104, a BIOS-ROM 105, a nonvolatile memory 106, a wireless communication device 107, and an embedded controller (EC) 108.

The CPU 101 is a processor configured to control individual operations of various modules in the tablet terminal 1. The CPU 101 is configured to execute various types of software to be loaded from the nonvolatile memory 106 to the main memory 103. These types of software include an operating system (OS) 201, and a screen luminance control utility program 202 and a handwriting input application program 203 that are operative under the control of the OS 201. The handwriting input application program 203 is a program configured to accept a touch input to the touch screen display 12. The function of displaying a path of a handwriting input (handwriting) to the screen, as described above, is provided by the handwriting input application program 203. The screen luminance control utility program 202 will be described later.

The CPU 101 is also configured to execute a basic input output system (BIOS) stored in the BIOS-ROM 105. The BIOS is a program for controlling the hardware.

The system controller 102 is a device configured to connect a local bus of the CPU 101 to each component. The system controller 102 includes a built-in memory controller configured to control access to the main memory 103. In addition, the system controller 102 is also configured to communicate with the graphics controller 104, for example, via a serial bus that conforms to the PCI EXPRESS specification. Furthermore, the system controller 102 includes a luminance controller 102A configured to control the luminance of the touch screen display 12 (LCD 12A), based on a signal from the illumination sensor 14. The control function of the luminance controller 102A can be turned on or off, in response to a command issued to the system controller 102.

The graphics controller 104 is a display controller configured to control the LCD 12A to be used as a display monitor of the tablet terminal 1. A signal generated by the graphics controller 104 is supplied to the LCD 12A. The LCD 12A is configured to display a screen image, based on this signal. A touch panel 12B and a digitizer 12C are disposed on the LCD 12A. The touch panel 12B is a capacitive pointing device for performing an input to the screen of the LCD 12A. A position of the screen with which the finger makes contact is detected by the touch panel 12B. The digitizer 12C is an electromagnetic induction type pointing device for performing an input to the screen of the LCD 12A. A position of the screen with which the pen (stylus) makes contact is detected by the digitizer 12C.

The wireless communication device 107 is a device configured to wirelessly communicate in accordance with a wireless LAN or a 3G mobile communication, for example. The EC 108 is a single-chip microcomputer including an embedded controller for controlling the electricity. The EC 108 is configured to power on or off the tablet terminal 1 in response to a user's operation of a power button.

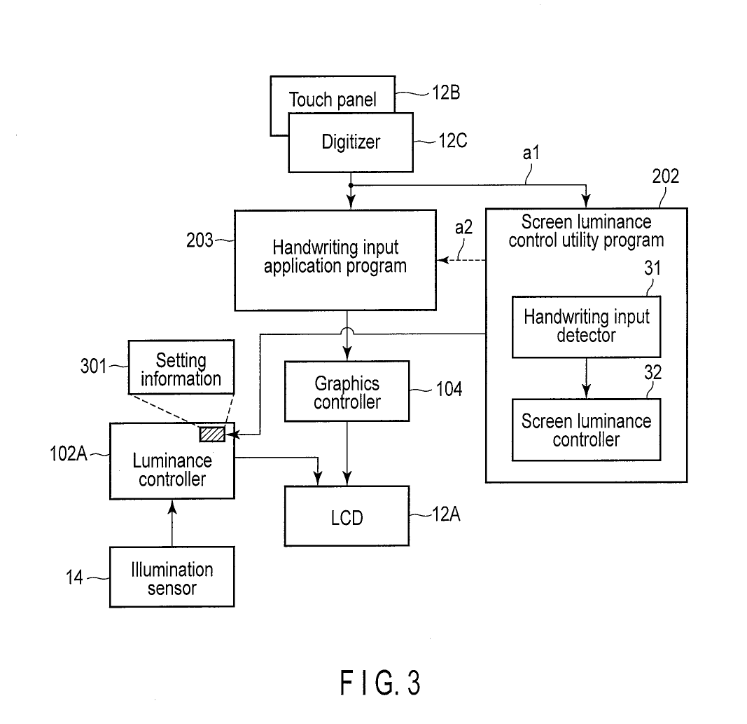

Next, a description will be given of a function of the screen luminance control utility program 202 operating in the tablet terminal 1, with reference to FIG. 3. FIG. 3 is an exemplary block diagram for explaining a function of the screen luminance control utility program 202.

As illustrated in FIG. 3, the screen luminance control utility program 202 includes a handwriting input detector 31 and a screen luminance controller 32.

As described above, the touch screen display 12 is configured to detect an operation of touching the screen through the touch panel 12B or the digitizer 12C. The handwriting input application program 203 is configured to: receive a signal from the touch panel 12B or the digitizer 12C; describe a path (handwriting) of a handwritten input; and display it on the touch screen display 12 (LCD 12A) through the graphics controller 104. In addition, the luminance controller 102A is configured to control the luminance of the touch screen display 12 (LCD 12A), based on an illuminance value detected by the illumination sensor 14.

The handwriting input detector 31 is a module configured to detect that the tablet terminal 1 moves into a state where a handwriting input to the touch screen display 12 would be performed. The screen luminance controller 32 is a module configured to turn off the control function of the luminance controller 102A, when the tablet terminal 1 moves into the state where a handwriting input to the touch screen display 12 would be performed. The luminance controller 102A has setting information 301 for enabling the function of controlling the luminance of the touch screen display 12 to be switched on or off. The screen luminance controller 32 is configured to turn off the control function of the luminance controller 102A, by issuing a command for updating the setting information 301 in the luminance controller 102A to the system controller 102. Thus, the screen luminance control utility program 202 can be a program configured to prevent the luminance of the touch screen display 12 from varying in the course of a handwriting input to the touch screen display 12.

Examples of a method in which the handwriting input detector 31 detects that the tablet terminal 1 moves into a state where a handwriting input to the touch screen display 12 would be performed can be considered to include two methods: (1) a method of monitoring an output of a signal from the touch panel 12B or the digitizer 12C (a1 in FIG. 3); and (2) a method of monitoring the activation of the handwriting input application program 203 (a2 in FIG. 3). The digitizer 12C can detect the presence of the pen at a nearby site. Therefore, even in the case of employing the method (1), when the user attempts to perform a handwriting input with the pen, the handwriting input detector 31 can detect that the tablet terminal 1 moves into the state where a handwriting input to the touch screen display 12 would be performed, before the handwriting input is actually performed. The handwriting input detector 31 may employ either the method (1) or (2). Alternatively, it may employ both of them in combination.

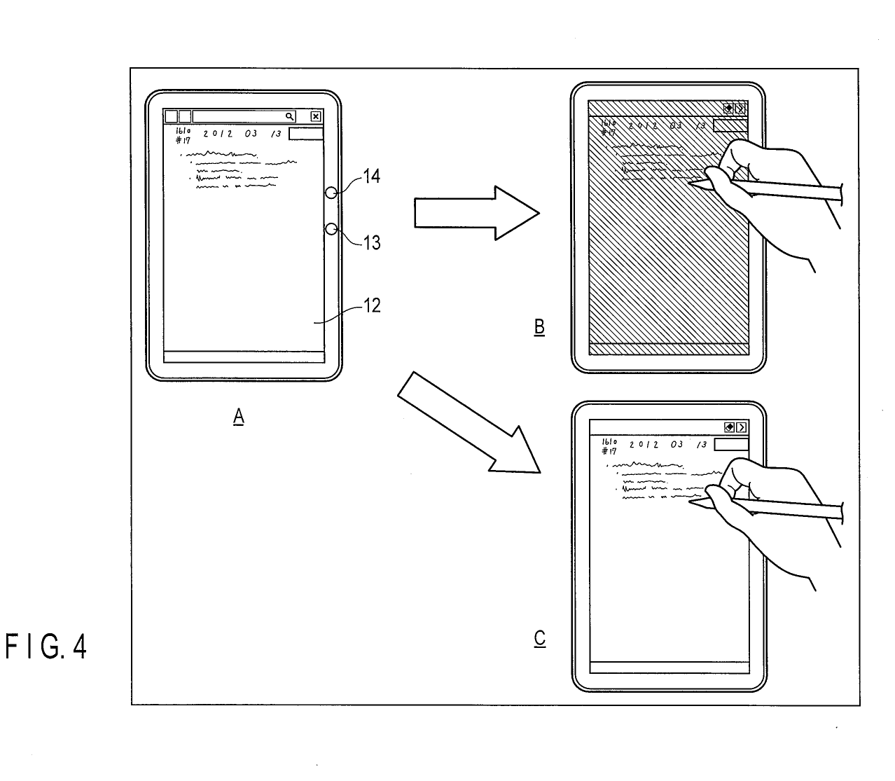

As illustrated in FIG. 4, as for the conventional technique, when the illumination sensor 14 is covered by the user's hand in the course of a handwriting input to the touch screen display 12 (although the illumination sensor 14 is disposed close to the camera 13 in order not to be covered by the user's hand), the luminance of the touch screen display 12 may vary (refer to parts “A” and “B” of FIG. 4). In contrast, as for the tablet terminal 1, the luminance of the touch screen display 12 can be prevented from varying (refer to parts “A” and “C” of FIG. 4).

The handwriting input detector 31 also detects that the tablet terminal 1 moves out of a state where a handwriting input to the touch screen display 12 would be performed. More concretely, the handwriting input detector 31 determines that the tablet terminal 1 moves out of a state in which a handwriting input to the touch screen display 12 would be performed, (1) when an output of a signal from the touch panel 12B or the digitizer 12C is interrupted beyond a predetermined period, (2) when the handwriting input application program 203 is terminated, or the like.

When the tablet terminal 1 moves out of a state in which a handwriting input to the touch screen display 12 would be performed, the screen luminance controller 32 turns on the control function of the luminance controller 102A again.

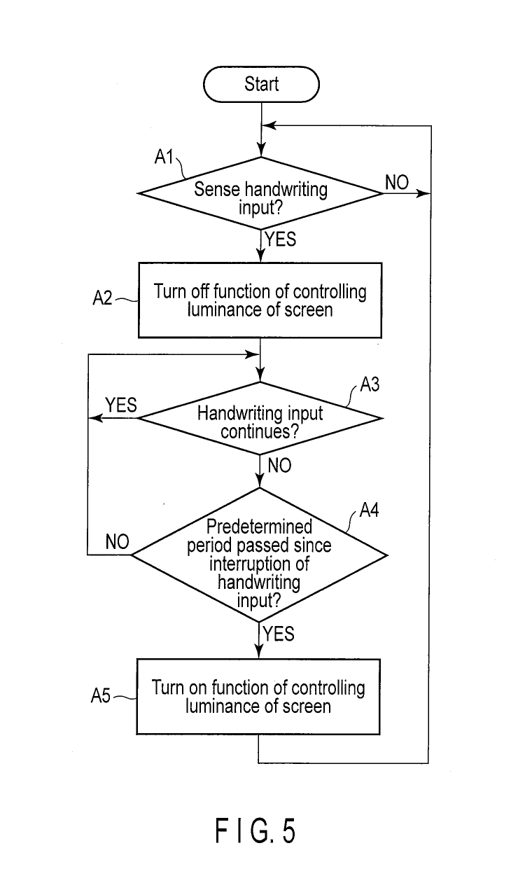

FIG. 5 is an exemplary flowchart showing a procedure (first pattern) through which the tablet terminal 1 controls the luminance of the touch screen display 12.

If sensing a handwriting input to the touch screen display 12 (or sensing the presence of the stylus at a nearby site) (YES in Block A1), the tablet terminal 1 turns off the function of controlling the luminance of the touch screen display 12 which is based on the illuminance value sensed by the illumination sensor 14 (Block A2).

After turning off the function of controlling the luminance of the touch screen display 12, the tablet terminal 1 monitors whether or not the handwriting input to the touch screen display 12 continues (Block A3). If the handwriting input has not continued (NO in Block A3), the tablet terminal 1 checks whether or not the predetermined period has passed since the handwriting input to the touch screen display 12 is interrupted (Block A4).

If the predetermined period has passed since the handwriting input to the touch screen display 12 is interrupted (YES in Block A4), the tablet terminal 1 turns on the function of controlling the luminance of the touch screen display 12 which is based on the illuminance value sensed by the illumination sensor 14 again (Block A5).

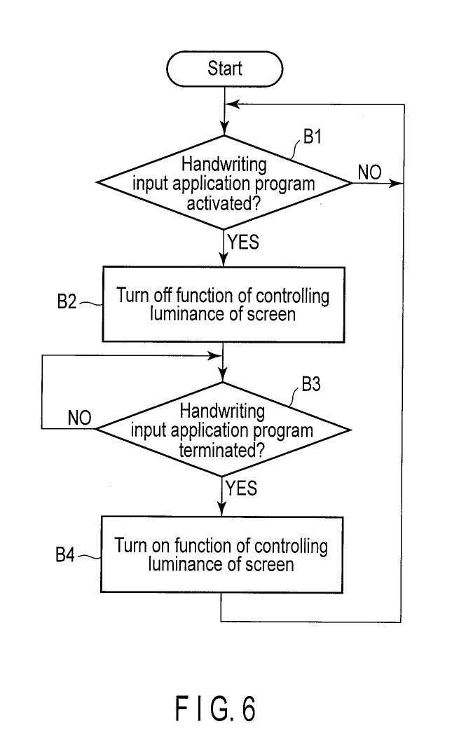

FIG. 6 is an exemplary flowchart showing another procedure (second pattern) through which the tablet terminal 1 controls the luminance of the touch screen display 12.

If a program configured to accept a handwriting input to the touch screen display 12, or the handwriting input application program 203, is activated (YES in Block B1), the tablet terminal 1 turns off the function of controlling the luminance of the touch screen display 12 which is based on the illuminance value sensed by the illumination sensor 14 (Block B2).

After turning off the function of controlling the luminance of the touch screen display 12, the tablet terminal 1 monitors whether or not the handwriting input application program 203 has been terminated (Block B3). If the handwriting input application program 203 has been terminated (YES in Block B3), the tablet terminal 1 turns on the function of controlling the luminance of the touch screen display 12 which is based on the illuminance value sensed by the illumination sensor 14 again (Block B4).

In this way, the tablet terminal 1 prevents the luminance of the touch screen display from varying in the course of a handwriting input to the touch screen display.

The procedure in each embodiment can be implemented using software (program). Therefore, it is possible to easily produce the effect of each embodiment, simply by installing the above program in a general-purpose computer from a computer-readable storage medium and executing it.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a touch screen display;
an illumination sensor;
a controller configured to control luminance of the touch screen display based on a signal from the illumination sensor; and
a setting switch configured to turn off control of the luminance by the controller to avoid a variation in luminance of the touch screen display, while an input to the touch screen display is performed.

2. The apparatus of claim 1, wherein the setting switch is configured to turn off control of the luminance by the controller, at least during a period in which the input to the touch screen display is being performed.

3. The apparatus of claim 2, wherein the setting switch is configured to turn on the control of the luminance by the controller, when the input to the touch screen display is interrupted beyond a first period after the setting switch turns off the control of the luminance by the controller.

4. The apparatus of claim 1, wherein:
the touch screen display comprises a digitizer; and
the setting switch is configured to turn off the control of the luminance by the controller, when the digitizer senses presence of a stylus.

5. The apparatus of claim 4, wherein the setting switch is configured to turn on the control of the luminance by the controller, if the digitizer does not sense the presence of the stylus beyond the first period after the setting switch turns off the control of the luminance by the controller.

6. The apparatus of claim 1, wherein the setting switch is configured to turn off the control of the luminance by the controller, when a first program configured to accept a handwriting input to the touch screen display is activated.

7. The apparatus of claim 6, wherein the setting switch is configured to turn on the control of the luminance by the controller, when the first program is terminated after the setting switch turns off the control of the luminance by the controller.

8. The apparatus of claim 1, wherein the illumination sensor is provided close to a periphery of a display surface of the touch screen display.

9. A method of controlling an electronic apparatus, the method comprising:
controlling luminance of a touch screen display based on a signal from an illumination sensor; and
turning off control of the luminance by controlling the luminance of the touch screen display to avoid a variation in luminance of the touch screen display, while an input to the touch screen display is performed.

10. The method of claim 9, wherein the turning off comprises turning off control of the luminance by controlling the luminance of the touch screen display, at least during a period in which the input to the touch screen display is being performed.

11. The method of claim 9, further comprising turning on the control of the luminance by controlling the luminance of the touch screen display, when the input to the touch screen display is interrupted beyond a first period after turning off the control of the luminance by controlling the luminance of the touch screen display.

12. The method of claim 9, wherein the turning off comprises turning off the control of the luminance by controlling the luminance of the touch screen display, when a digitizer in the touch screen display senses presence of a stylus.

13. The method of claim 12, further comprising turning on the control of the luminance by controlling the luminance of the touch screen display, when the digitizer fails to sense the presence of the stylus beyond the first period after turning off the control of the luminance by controlling the luminance of the touch screen display.

14. The method of claim 9, wherein the turning off comprises turning off the control of the luminance by controlling the luminance of the touch screen display, when a first program configured to accept a handwriting input to the touch screen display is activated.

15. The method of claim 14, further comprising turning on the control of the luminance by controlling the luminance of the touch screen display, when the first program is terminated after turning off the control of the luminance by controlling the luminance of the touch screen display.

16. A computer-readable, non-transitory storage medium having stored thereon a computer program which is executable by a computer, the computer program controlling the computer to function as:
a controller configured to control luminance of a touch screen display based on a signal from an illumination sensor; and
a setting switch configured to turn off control of the luminance by the controller to avoid a variation in luminance of the touch screen display, while an input to the touch screen display is performed.

17. The medium of claim 16, wherein the setting switch is configured to turn off control of the luminance by the controller, at least during a period in which the input to the touch screen display is being performed.

18. The medium of claim 16, wherein the setting switch is configured to turn off the control of the luminance by the controller, when a digitizer in the touch screen display senses presence of a stylus.

19. The medium of claim 16, wherein the setting switch is configured to turn off the control of the luminance by the controller, when a first program configured to accept a handwriting input to the touch screen display is activated.
